(19) United States
(12) Patent Application Publication
(10) Pub. No.: US 2025/0334791 A1
(43) Pub. Date: Oct. 30, 2025

(54) STIFFENING STRUCTURE AND MOUNTING STRUCTURE FOR A MICROELECTROMECHANICAL SYSTEM MIRROR

(71) Applicant: Infineon Technologies AG, Neubiberg (DE)

(72) Inventors: Theresa LUTZ, Göttingen (DE); Stephan Gerhard ALBERT, München (DE); Malika BELLA, Ottobrunn (DE)

(21) Appl. No.: 19/170,115

(22) Filed: Apr. 4, 2025

Related U.S. Application Data
(60) Provisional application No. 63/639,934, filed on Apr. 29, 2024.

(51) Int. Cl. G02B 26/08; G02B 26/10

(52) U.S. Cl. CPC G02B 26/0833; G02B 26/101

(57) ABSTRACT

A scanning structure includes a mirror plate with a first symmetry axis coincident with a first scanning axis and a second symmetry axis coincident with a second scanning axis; a stiffening structure arranged underneath the mirror plate; and a connector ring. The stiffening structure includes an inner cylinder at a center; an outer ring arranged at a circumferential edge of the mirror plate; and two or more radial bars that extend in respective radial directions to couple the inner cylinder and the outer ring. Each radial bar is arranged at a first absolute radial angle relative to the first symmetry axis. The connector ring is coupled to the outer ring by a plurality of connector structures. Each connector structure is arranged at a second absolute radial angle relative to the first symmetry axis, the second absolute radial angle being less than or equal to the first absolute radial angle.

### CROSS-REFERENCE TO RELATED APPLICATION

This Patent application claims priority to U.S. Provisional Patent Application No. 63/639,934, filed on Apr. 29, 2024, entitled “STIFFENING STRUCTURE AND MOUNTING STRUCTURE FOR A MEMS MIRROR,” which is hereby expressly incorporated by reference herein.

### BACKGROUND

A scanning system may use two-dimensional scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Different scanning patterns can be obtained by using different fixed frequency ratios between the first scanning frequency and the second scanning frequency. Reducing dynamic deformation of a mirror body of a scanning mirror is important for improving a quality of a light beam transmitted by a scanner and increasing a scanning resolution of the scanner.

### SUMMARY

In some implementations, a method, a device, a system, an apparatus, an optical device, an optical system, an optical assembly, a beam scanning system, and/or a scanning structure, as substantially described herein with reference to and as illustrated by the accompanying specification, appendix, and drawings.

In some implementations, a scanning structure includes a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an inner cylinder arranged at a center of the stiffening structure; an outer ring arranged at a circumferential edge of the mirror plate, wherein the outer ring has a first outer diameter; and two or more radial bars that extend in respective radial directions and are coupled to the inner cylinder and the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

In some implementations, a scanning structure includes a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an outer ring arranged at a circumferential edge of the mirror plate, wherein the outer ring has a first outer diameter; and two radial bars that extend in respective radial directions and intersect at a center of the stiffening structure, wherein the two radial bars are coupled to the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

In some implementations, a scanning structure includes a mirror plate comprising an upper surface, a lower surface, a first symmetry axis, a second symmetry axis that is orthogonal to the first symmetry axis and is coincident with a scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an inner cylinder arranged at a center of the stiffening structure; an outer ring arranged at a circumferential edge of the mirror plate, wherein the outer ring has a first outer diameter; and two or more radial bars that extend in respective radial directions and are coupled to the inner cylinder and the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

### BRIEF DESCRIPTION OF THE DRAWINGS

Implementations are described herein making reference to the appended drawings.

FIG. 1A is a schematic block diagram of a two-dimensional (2D) scanning system according to one or more implementations.

FIG. 1B is a schematic block diagram of a 2D scanning system according to one or more implementations.

FIGS. 2A-2C show a scanning structure of a microelectromechanical system (MEMS) mirror according to one or more implementations.

FIG. 3 shows a scanning structure of a MEMS mirror according to one or more implementations.

FIGS. 4A-4C show top views of alternative scanning structures of a MEMS mirror according to one or more implementations.

FIGS. 5A-5J show bottom views of alternative scanning structures of a MEMS mirror according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view, rather than in detail, in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually interchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling (e.g., any connection or coupling without additional intervening elements) may also be implemented by an indirect connection or coupling (e.g., a connection or coupling with one or more additional intervening elements, or vice versa) as long as the general purpose of the connection or coupling (e.g., to transmit a certain kind of signal or to transmit a certain kind of information) is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, a signal with an approximate signal value may practically have a signal value within 5% of the approximate signal value.

In the present disclosure, expressions including ordinal numbers, such as “first”, “second”, and/or the like, may modify various elements. However, such elements are not limited by such expressions. For example, such expressions do not limit the sequence and/or importance of the elements. Instead, such expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A microelectromechanical system (MEMS) mirror can be driven about two or more scanning axes for use as a scanning device. Alternatively, two MEMS mirrors driven about a respective scanning axis may be optically coupled to form a scanning system. A MEMS mirror-based light beam scanner is one way to implement image projection technologies and object detection technologies such as Light Detection and Ranging (LIDAR). These technologies may rely on a two-dimensional (2D) scanning pattern, such as a Lissajous scanning pattern, that relies on accurately synchronized scanning axes driven at scanning frequencies that have a fixed frequency ratio.

Resonant MEMS scanning micromirrors show great potential as a key component of future miniaturized projection systems. MEMS scanning micromirrors are microstructured resonators. Thus, MEMS scanning micromirrors feature structural members, such as springs, that function as spring system (e.g., a suspension system) and also feature a rigid mirror body, which is suspended by the suspension system. Together, the springs and the rigid mirror body form a spring-mass system that can be excited in one or several eigenmodes by a suitable actuation mechanism to induce a desired oscillatory motion of the rigid mirror body. Usually, in MEMS the actuation mechanism is either electrostatic (capacitive), piezoelectric, or electromagnetic. For micromirrors implemented in projection applications, desired eigenmodes are two perpendicular rotatory motions of the rigid mirror body. The rigid mirror body typically has a circular or elliptical surface with high reflectivity, which represents a reflective surface that may also be referred to as a mirror surface. Often, the entire MEMS structure is called a MEMS mirror. When one or two rotatory eigenmodes of the rigid mirror body are excited, in which the rotation axis or axes lie(s) in a plane of the reflective surface, a normal to the plane of the reflective surface will travel in an oscillatory motion in one or two directions. If a light beam of a collimated light source, such as a laser, is directed onto the reflective surface, an angle of incidence will change according to a motion of the normal. The motion of the normal will steer a reflected beam accordingly. If laser beam scanning is performed in two directions and in a controlled fashion, the reflected beam can be steered at a solid angle with knowledge of current angular coordinates with respect to the normal of the reflective surface at a resting position. If an RGB light source, having three laser diodes forming RGB channels, is pulsed and turned on and off in a controlled fashion according to a current position of the MEMS mirror, a beam scanning system can form a projection apparatus that may project desired image content on a screen.

A performance of the beam scanning system may be defined by at least four key properties of the MEMS mirror, including the frequencies of two operational rotatory eigenmodes in which the MEMS mirror is excited, a diameter of reflective surface of the mirror body, maximum angular amplitudes of the resonant oscillatory motions, to which the two rotatory eigenmodes are excited, and a dynamic deformation of the reflective surface of the mirror body.

The frequencies of the two operational rotatory eigenmodes determine the angular distance, which the trajectories of both scanning axes can travel in a given amount of time. The trajectory of one scanning axis in single operation may be defined by an angle of the reflective surface normal measured versus the normal at the rest position as a function of time. In simultaneous excitation of both axes, the trajectory is a 2D-angle of the reflective surface normal as a function of time measured versus the normal at the rest position. The more angular distance the reflective surface can travel in a given amount of time, the more image content can be projected in the same amount of time. For this reason, the frequencies can be understood to determine a resolution of a projection device.

The MEMS mirror is part of an optical system. For this reason, the mirror body needs a certain diameter in order to avoid unwanted optical effects, such as diffraction.

The maximum angular amplitudes define the solid angle, in which the trajectory of the reflective surface normal travels. Thus, the maximum angular amplitudes define the optical field-of-view of the projection, and thus a size of a projected image at a given distance from the projection device.

The mirror body is not perfectly rigid. Since the mirror body is repeatedly accelerated and decelerated in resonant motions, the mirror body will deform under its own inertia. This is called dynamic deformation. Dynamic deformation deteriorates an optical projection quality because the reflective surface will not be a perfect plane, but will instead have surface regions that are out-of-plane (e.g., curved or otherwise deformed from being straight).

A challenge in designing MEMS mirrors is therefore to make the mirror body as rigid as possible while reducing an inertia or mass of the mirror body in order to reduce the dynamic deformation and yield a better projection quality. At the same time, this process often also reduces the moments of inertia associated with the two rotatory eigenmodes. Reduction of inertia leads to higher frequencies, and thus higher resolution. Alternatively, the reduction in inertia can be leveraged to reduce mechanical stress in the suspension system. For example, a basic relation of frequency f, spring constant k, and inertia I associated with a certain mode can be expressed by the following equation 2πf=√(k/I). A reduction in inertia allows a reduction of the spring constant, when a constant frequency is desired. A reduction of the spring constant can usually be translated into a reduction of maximum mechanical stress appearing in the suspension system during the oscillation, which may improve the reliability of the MEMS mirror and/or will allow for higher maximum angular amplitudes.

Some implementations disclosed herein are directed to a stiffening structure of a lightweight mirror body that is designed to achieve low dynamic deformation and high oscillations frequencies with low mechanical stress. For example, a lightweight stiffening structure may be provided underneath a thin mirror plate and a mounting system (e.g., connector ring) with certain dimensions in order to reduce dynamic deformation for a mirror body, enable higher oscillation frequencies, and/or enable higher maximum angular amplitudes.

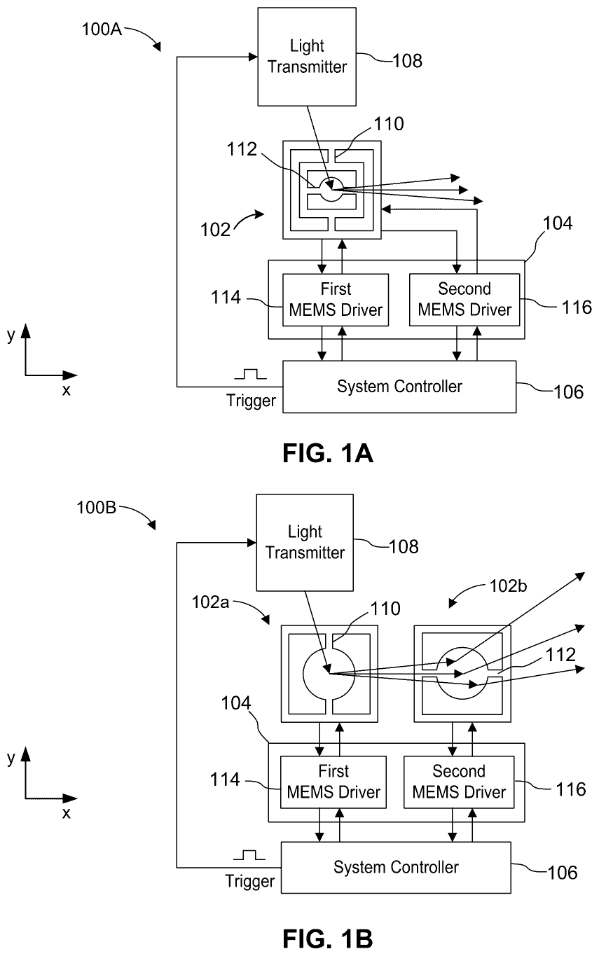

FIG. 1A is a schematic block diagram of a 2D scanning system 100A, according to one or more implementations. In particular, the 2D scanning system 100A includes a MEMS mirror 102 implemented as a single scanning structure that is configured to steer or otherwise deflect light beams according to a 2D scanning pattern. The 2D scanning system 100A further includes a MEMS driver system 104, a system controller 106, and a light transmitter 108.

In the example shown in FIG. 1A, the MEMS mirror 102 is a mechanical moving mirror (e.g., a MEMS micro-mirror) integrated on a semiconductor chip (not shown). The MEMS mirror 102 is configured to rotate or oscillate via rotation about two scanning axes that are typically orthogonal to each other. For example, the two scanning axes may include a first scanning axis 110 that enables the MEMS mirror 102 to steer light in a first scanning direction (e.g., an x-direction) and a second scanning axis 112 that enables the MEMS mirror 102 to steer light in a second scanning direction (e.g., a y-direction). As a result, the MEMS mirror 102 can direct light beams in two dimensions according to the 2D scanning pattern, and may be referred to as a 2D MEMS mirror.

The MEMS mirror 102 may include a mirror plate that has a reflective surface for reflecting light. For example, a reflective layer may be arranged on an upper surface of the mirror plate to form the reflective surface. The mirror plate may be attached to a suspension system by, for example, suspension structures, such as one or more pairs suspension beams. A pair of suspension beams may extend along a respective scanning axis for attaching the mirror plate to a rotationally fixed frame. The suspension beams of a pair of suspension beams may be arranged on opposite sides of the mirror plate. The suspension system suspends the mirror plate over a cavity to provide the mirror plate with sufficient clearance to rotate about the two scanning axes. Thus, the suspension system enables rotation of the mirror plate about the two scanning axes.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100A may be configured to transmit successive light beams (e.g., as successive light pulses) in different scanning directions to scan the field-of-view. In some implementations, the 2D scanning system 100A may be configured to transmit a continuous light beam (e.g., as a frequency-modulated continuous-wave (FMCW)) in different scanning directions to scan the field-of-view. In other words, the field-of-view can be illuminated by a scanning operation. In general, an entire field-of-view represents a scanning area defined by a full range of motion of the MEMS mirror 102. Thus, the entire field-of-view is delineated by a left edge, a right edge, a bottom edge, and a top edge. The entire field-of-view can also be referred to as a field of illumination or as a projection area in a projection plane onto which an image is projected.

The MEMS mirror 102 can direct a transmitted light beam at a desired 2D coordinate (e.g., an x-y coordinate) in the field-of-view. In some implementations, such as LIDAR implementations, the MEMS mirror 102 may be arranged to receive transmitted light beams from the light transmitter 108 and steer (scan) the transmitted light beams into the field-of-view to perform a scanning of the environment. The transmitted light beams may be backscattered by one or more objects back toward the 2D scanning system 100A as reflected light beams where the reflected light beams are detected by a sensor. For example, the sensor may be a photodetector array. The sensor may convert each reflected light beam into an electric signal (e.g., a current signal or a voltage signal) that may be further processed by the 2D scanning system 100A to generate object data or an image. In such implementations, the desired 2D coordinate may correspond to a particular transmission direction in the field-of-view that is targeted by the transmitted light beam for object detection, with different 2D coordinates corresponding to different transmission directions.

Alternatively, in some implementations, such as image projection systems, the desired 2D coordinate may correspond to an image pixel of a projected image, with different 2D coordinates corresponding to different image pixels of the projected image. In some implementations, an image projection system may include wearable augmented reality goggles, and the MEMS mirror 102 may be arranged to receive the transmitted light beams and steer (scan) the transmitted light beams onto a retina of a human eye in order to render an image thereon. In some implementations, an image projection system may include a head-up display (HUD) and the MEMS mirror 102 may be arranged to receive the transmitted light beams and steer (scan) the transmitted light beams onto a display screen. For image projection, the light transmitter 108 may be a red-green-blue (RGB) light transmitter that generates RGB light beams (e.g., laser pulses having a mixture of red, green, and/or blue light) to be projected onto a projection plane. An RGB light beam may be referred to as a “pixel light beam” that includes one or more colors of light depending on the desired pixel color to be projected into the field-of-view. For example, a particular RGB light beam may correspond to a pixel of an image projected into the field-of-view or an image projected onto a display, and different RGB light beams may be transmitted for different pixels of the image or for different image frames.

Accordingly, multiple light beams transmitted at different transmission times or a continuous light beam can be steered by the MEMS mirror 102 at the different 2D coordinates of the field-of-view in accordance with the 2D scanning pattern. The MEMS mirror 102 can be used to scan the field-of-view in both scanning directions by changing an angle of deflection of the MEMS mirror 102 on each of the first scanning axis 110 and the second scanning axis 112.

A rotation of the MEMS mirror 102 on the first scanning axis 110 may be performed between two predetermined extremum deflection angles (e.g., +/−5 degrees, +/−15 degrees, etc.). Likewise, a rotation of the MEMS mirror 102 on the second scanning axis 112 may be performed between two predetermined extremum deflection angles (e.g., +/−5 degrees, +/−15 degrees, etc.). In some implementations, depending on the 2D scanning pattern, the two predetermined extremum deflection angles used for the first scanning axis 110 may be the same as the two predetermined extremum deflection angles used for the second scanning axis 112. In some implementations, depending on the 2D scanning pattern, the two predetermined extremum deflection angles used for the first scanning axis 110 may be different from the two predetermined extremum deflection angles used for the second scanning axis 112.

In some implementations, the MEMS mirror 102 can be a resonator (e.g., a resonant MEMS mirror) configured to oscillate side-to-side about the first scanning axis 110 at a first frequency (e.g., a first resonance frequency) and configured to oscillate top-to-bottom about the second scanning axis 112 at a second frequency (e.g., a second resonance frequency). Thus, the MEMS mirror 102 can be continuously driven about the first scanning axis 110 and the second scanning axis 112 to perform a continuous scanning operation. As a result, light beams reflected by the MEMS mirror 102 are scanned into the field-of-view in accordance with the 2D scanning pattern.

Different frequencies or a same frequency may be used for the first scanning axis 110 and the second scanning axis 112 for defining the 2D scanning pattern. For example, a raster scanning pattern or a Lissajous scanning pattern may be achieved by using different frequencies for the first frequency and the second frequency. Raster scanning and Lissajous scanning are two types of scanning that can be implemented in display applications, light scanning applications, and light steering applications, to name a few. As an example, Lissajous scanning is typically performed using two resonant scanning axes which are driven at different constant scanning frequencies with a defined fixed frequency ratio therebetween that forms a specific Lissajous pattern and frame rate. In order to properly carry out the Lissajous scanning and the raster scanning, synchronization of the two scanning axes is performed by the system controller 106 in conjunction with transmission timings of the light transmitter 108.

For each respective scanning axis, including the first scanning axis 110 and the second scanning axis 112, the MEMS mirror 102 includes an actuator structure used to drive the MEMS mirror 102 about the respective scanning axis. Each actuator structure may include interdigitated finger electrodes made of interdigitated mirror combs and frame combs to which a drive voltage (e.g., an actuation signal or driving signal) is applied by the MEMS driver system 104. Applying a difference in electrical potential between interleaved mirror combs and frame combs creates a driving force between the mirror combs and the frame combs, which creates a torque on a mirror body of the MEMS mirror 102 about the intended scanning axis. The drive voltage can be toggled between two voltages, resulting in an oscillating driving force. The oscillating driving force causes the MEMS mirror 102 to oscillate back and forth on the respective scanning axis between two extrema. Depending on the configuration, this actuation can be regulated or adjusted by adjusting a drive voltage off time, a voltage level of the drive voltage (e.g., a high-voltage (HV) level), or a duty cycle.

In other examples, the MEMS mirror 102 may use other actuation methods to drive the MEMS mirror 102 about the respective scanning axes. For example, these other actuation methods may include electromagnetic actuation and/or piezoelectric actuators. In electromagnetic actuation, the MEMS mirror 102 may be immersed in a magnetic field and an alternating electric current through conductive paths may create the oscillating torque around the scanning axis. Piezoelectric actuators may be integrated in leaf springs of the MEMS mirror 102, or the leaf springs may be made of piezoelectric material to produce alternating beam bending forces in response to an electrical signal to generate the oscillation torque.

The MEMS driver system 104 is configured to generate driving signals (e.g., actuation signals) to drive the MEMS mirror 102 about the first scanning axis 110 and the second scanning axis 112. In particular, the MEMS driver system 104 is configured to apply the driving signals to the actuator structure of the MEMS mirror 102. In some implementations, the MEMS driver system 104 includes a first MEMS driver 114 configured to drive the MEMS mirror 102 about the first scanning axis 110 and a second MEMS driver 116 configured to drive the MEMS mirror 102 about the second scanning axis 112. In implementations in which the MEMS mirror 102 is used as an oscillator, the first MEMS driver 114 is configured to drive an oscillation of the MEMS mirror 102 about the first scanning axis 110 at the first frequency, and the second MEMS driver 116 is configured to drive an oscillation of the MEMS mirror 102 about the second scanning axis 112 at the second frequency.

The first MEMS driver 114 may be configured to sense a first rotational position of the MEMS mirror 102 about the first scanning axis 110 and provide first position information indicative of the first rotational position (e.g., tilt angle or degree of rotation about the first scanning axis 110) to the system controller 106. Similarly, the second MEMS driver 116 may be configured to sense a second rotational position of the MEMS mirror 102 about the second scanning axis 112 and provide second position information indicative of the second rotational position (e.g., tilt angle or degree of rotation about the second scanning axis 112) to the system controller 106.

The system controller 106 may use the first position information and the second position information to trigger light beams at the light transmitter 108. For example, the system controller 106 may use the first position information and the second position information to set a transmission time of light transmitter 108 in order to target a particular 2D coordinate of the 2D scanning pattern. Thus, a higher accuracy in position sensing of the MEMS mirror 102 by the first MEMS driver 114 and the second MEMS driver 116 may result in the system controller 106 providing more accurate and precise control of other components of the 2D scanning system 100A.

As noted above, the first MEMS driver 114 and the second MEMS driver 116 may apply a drive voltage to a corresponding actuator structure of the MEMS mirror 102 as the driving signal to drive a rotation (e.g., an oscillation) of the MEMS mirror 102 about a respective scanning axis (e.g., the first scanning axis 110 or the second scanning axis 112). The drive voltage can be switched or toggled between an HV level and a low-voltage (LV) level resulting in an oscillating driving force. In some implementations, the LV level may be zero (e.g., the drive voltage is off), but is not limited thereto and could be a non-zero value. When the drive voltage is toggled between an HV level and an LV level and the LV level is set to zero, it can be said that the drive voltage is toggled on and off (HV on/off). The oscillating driving force causes the MEMS mirror 102 to oscillate back and forth on the first scanning axis 110 or the second scanning axis 112 between two extrema. The drive voltage may be a constant drive voltage, meaning that the drive voltage is the same voltage when actuated (e.g., toggled on), or one or both of the HV level or the LV level of the drive voltage may be adjustable. However, it will be understood that the drive voltage is being toggled between the HV level and the LV level in order to produce the mirror oscillation. Depending on a configuration, this actuation can be regulated or adjusted by the system controller 106 by adjusting the drive voltage off time, a voltage level of the drive voltage, or a duty cycle. As noted above, frequency and phase of the drive voltage can also be regulated and adjusted.

In some implementations, the system controller 106 is configured to set a driving frequency of the MEMS mirror 102 for each scanning axis and is capable of synchronizing the oscillations about the first scanning axis 110 and the second scanning axis 112. In particular, the system controller 106 may be configured to control an actuation of the MEMS mirror 102 about each scanning axis by controlling the driving signals. The system controller 106 may control the frequency, the phase, the duty cycle, the HV level, and/or the LV level of the driving signals to control the actuations about the first scanning axis 110 and the second scanning axis 112. The actuation of the MEMS mirror 102 about a particular scanning axis controls its range of motion and scanning rate about that particular scanning axis.

For example, to make a Lissajous scanning pattern reproduce itself periodically with a frame rate frequency, the first frequency at which the MEMS mirror 102 is driven about the first scanning axis 110 and the second frequency at which the MEMS mirror 102 is driven about the second scanning axis 112 are different. A difference between the first frequency and the second frequency is set by a fixed frequency ratio that is used by the 2D scanning system 100A to form a repeatable Lissajous pattern (frame) with a frame rate. A new frame begins each time the Lissajous scanning pattern restarts, which may occur when a phase difference between a mirror phase about the first scanning axis 110 and a mirror phase about the second scanning axis 112 is zero. The system controller 106 may set the fixed frequency ratio and synchronize the oscillations about the first scanning axis 110 and the second scanning axis 112 to ensure that this fixed frequency ratio is maintained based on the first position information and the second position information received from the first MEMS driver 114 and the second MEMS driver 116, respectively.

The light transmitter may include one or more light sources, such as one or more laser diodes or one or more light emitting diodes, for generating one or more light beams. In some implementations, the light transmitter 108 may be configured to sequentially transmit a plurality of light beams (e.g., light pulses) as the MEMS mirror 102 changes its transmission direction in order to target different 2D coordinates. The plurality of light beams may include visible light, infrared (IR) light, or other types of illumination signals, depending on an application of the 2D scanning system 100A. A transmission sequence of the plurality of light beams and a timing thereof may be implemented by the light transmitter 108 according to a trigger signal received from the system controller 106. Alternatively, in some implementations, the light transmitter 108 may be configured to transmit a continuous light beam as the MEMS mirror 102 changes its transmission direction in order to target different 2D coordinates. The continuous light beam may include visible light, IR light, or another type of illumination signal, depending on the application of the 2D scanning system 100A.

The system controller 106 is configured to control components of the 2D scanning system 100A. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuitry that is configured to generate control signals for controlling the light transmitter 108, the first MEMS driver 114, and the second MEMS driver 116.

The system controller 106 is configured to set the driving frequencies of the MEMS mirror 102 for the first scanning axis 110 and the second scanning axis 112 and is capable of synchronizing the oscillations about the first scanning axis 110 and the second scanning axis 112 to generate the 2D scanning pattern. In some implementations, in which the plurality of light beams is used, the system controller 106 may be configured to generate the trigger signal used for triggering the light transmitter 108 to generate the plurality of light beams. Using the trigger signal, the system controller 106 can control the transmission times of the plurality of light beams of the light transmitter 108 to achieve a desired illumination pattern within the field-of-view. The desired illumination pattern is produced by a combination of the 2D scanning pattern produced by the MEMS mirror 102 and the transmission times triggered by the system controller 106. In some implementations in which the continuous light beam is used, the system controller 106 may be configured to control a frequency modulation of the continuous light beam via a control signal provided to the light transmitter 108.

As indicated above, FIG. 1A is provided as an example. Other examples may differ from what is described with regard to FIG. 1A. In practice, the 2D scanning system 100A may include additional components, fewer components, different components, or differently arranged components than those shown in FIG. 1A without deviating from the disclosure provided above. In addition, in some implementations, the 2D scanning system 100A may include one or more additional 2D MEMS mirrors or one or more additional light transmitters used to scan one or more additional field-of-views. Additionally, two or more components shown in FIG. 1A may be implemented within a single component, or a single component shown in FIG. 1A may be implemented as multiple, distributed components. Additionally, or alternatively, a set of components (e.g., one or more components) of the 2D scanning system 100A may perform one or more functions described as being performed by another set of components of the 2D scanning system 100A.

FIG. 1B is a schematic block diagram of a 2D scanning system 100B according to one or more implementations. In particular, the 2D scanning system 100B includes two MEMS mirrors, a first MEMS mirror 102a and a second MEMS mirror 102b, that are optically coupled in series to steer or otherwise deflect light beams according to a 2D scanning pattern. The first MEMS mirror 102a and the second MEMS mirror 102b are similar to the MEMS mirror 102 described in FIG. 1A, with the exception that the first MEMS mirror 102a and the second MEMS mirror 102b are configured to rotate about a single scanning axis instead of two scanning axes. The first MEMS mirror 102a is configured to rotate about the first scanning axis 110 to steer light in the x-direction and the second MEMS mirror 102b is configured to rotate about the second scanning axis 112 to steer light in the y-direction. Similar to the MEMS mirror 102 described in FIG. 1A, the first MEMS mirror 102a and the second MEMS mirror 102b may be resonant MEMS mirrors configured to oscillate about the first scanning axis 110 and the second scanning axis 112, respectively.

Because each of the first MEMS mirror 102a and the second MEMS mirror 102b is configured to rotate about a single scanning axis, each of the first MEMS mirror 102a and the second MEMS mirror 102b is responsible for scanning light in one dimension. As a result, the first MEMS mirror 102a and the second MEMS mirror 102b may be referred to as one-dimensional (1D) MEMS mirrors. In the example shown in FIG. 1B, the first MEMS mirror 102a and the second MEMS mirror 102b are used together to steer light beams in two dimensions. The first MEMS mirror 102a and the second MEMS mirror 102b are arranged sequentially along a transmission path of the light beams such that one of the MEMS mirrors (e.g., the first MEMS mirror 102a) first receives a light beam and steers the light beam in a first dimension, and the second one of the MEMS mirrors (e.g., the second MEMS mirror 102b) receives the light beam from the first MEMS mirror 102a and steers the light beam in a second dimension. As a result, the first MEMS mirror 102a and the second MEMS mirror 102b operate together to steer the light beam generated by the light transmitter 108 in two dimensions. In this way, the first MEMS mirror 102a and the second MEMS mirror 102b can direct the light beam at a desired 2D coordinate (e.g., an x-y coordinate) in the field-of-view. Multiple light beams can be steered by the first MEMS mirror 102a and the second MEMS mirror 102b at different 2D coordinates of a 2D scanning pattern.

The MEMS driver system 104, the system controller 106, and the light transmitter 108 are configured to operate as similarly described above in reference to FIG. 1A. The first MEMS driver 114 is electrically coupled to the first MEMS mirror 102a to drive the first MEMS mirror 102a about the first scanning axis 110 and to send a position of the first MEMS mirror 102a about the first scanning axis 110 to provide first position information to the system controller 106. Similarly, the second MEMS driver 116 is electrically coupled to the second MEMS mirror 102b to drive the second MEMS mirror 102b about the second scanning axis 112 and to send a position of the second MEMS mirror 102b about the second scanning axis 112 to provide second position information to the system controller 106.

As indicated above, FIG. 1B is provided as an example. Other examples may differ from what is described with regard to FIG. 1B. In practice, the 2D scanning system 100B may include additional components, fewer components, different components, or differently arranged components than those shown in FIG. 1B without deviating from the disclosure provided above. In addition, in some implementations, the 2D scanning system 100B may include one or more additional 1D MEMS mirrors or one or more additional light transmitters used to scan one or more additional field-of-views. Additionally, two or more components shown in FIG. 1B may be implemented within a single component, or a single component shown in FIG. 1B may be implemented as multiple, distributed components. Additionally, or alternatively, a set of components (e.g., one or more components) of the 2D scanning system 100B may perform one or more functions described as being performed by another set of components of the 2D scanning system 100B.

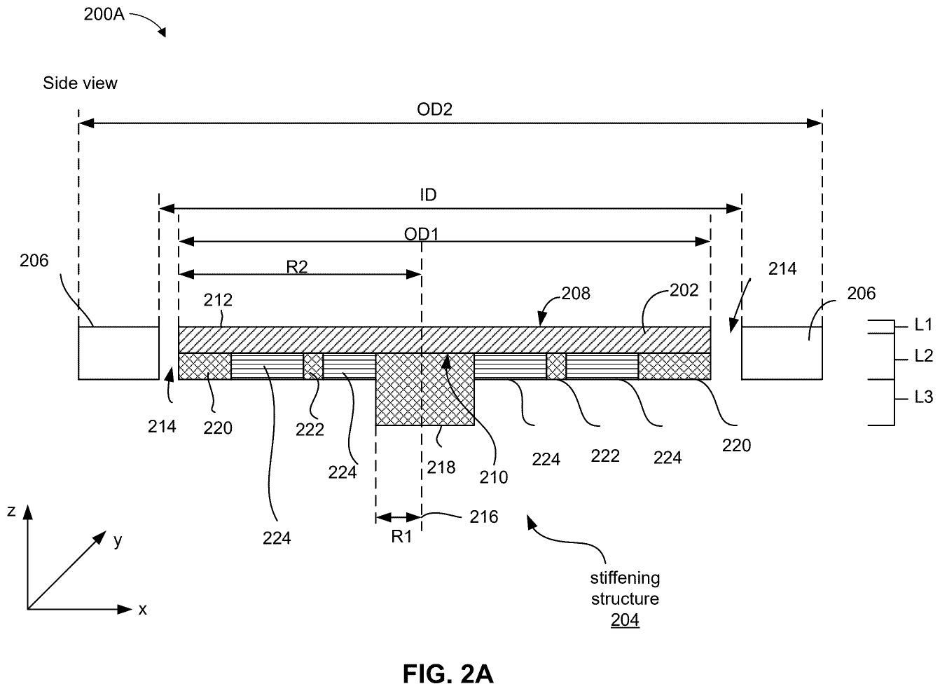

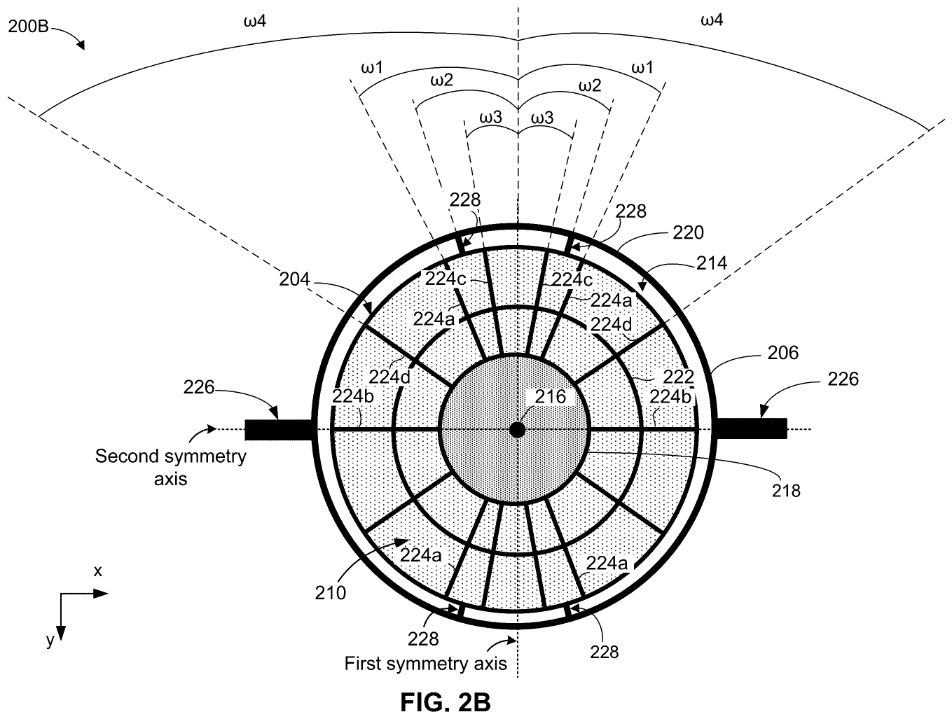

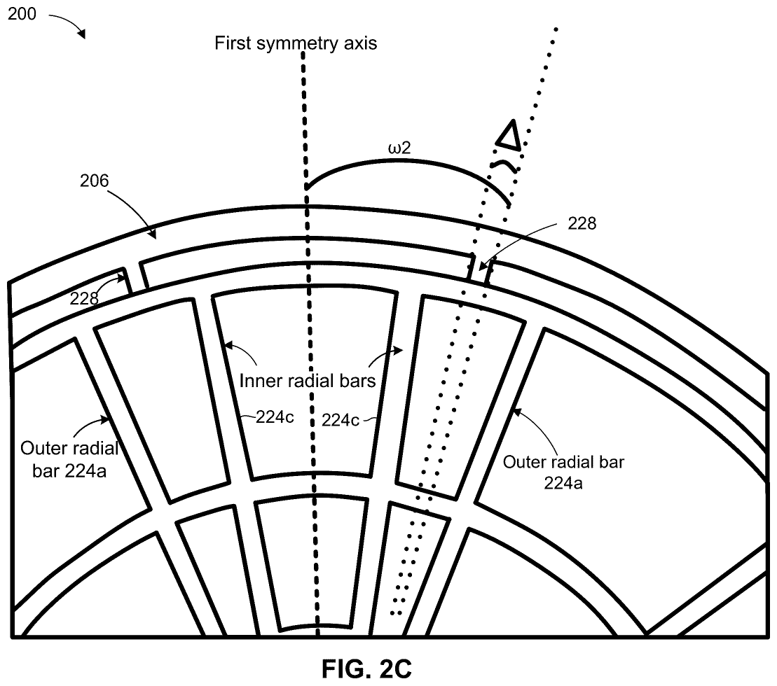

FIGS. 2A-2C show a scanning structure 200 of a MEMS mirror according to one or more implementations. In particular, FIG. 2A shows a cross-sectional view (e.g., side view) of the scanning structure 200. FIG. 2B shows a bottom view of the scanning structure 200. FIG. 2C shows an expanded view of a portion of FIG. 2B.

As shown in FIG. 2A, the scanning structure 200 includes a mirror plate 202, a stiffening structure 204, and a connector ring 206. The mirror plate 202 may also be referred to as a mirror body. The mirror plate 202 includes an upper surface 208 (top surface) and a lower surface 210 (bottom surface). A reflective layer 212 may be arranged on the upper surface 208 to form a reflective surface. Accordingly, the mirror plate 202 may include an upper, reflective surface (e.g. mirror surface). Moreover, the lower surface 210 is coupled to the stiffening structure 204.

In addition, the mirror plate 202 may have a first symmetry axis coincident with a first scanning axis (e.g., first scanning axis 110), and a second symmetry axis coincident with a second scanning axis (e.g., second scanning axis 112) that is orthogonal to the first scanning axis. Thus, scanning structure 200 includes two axes of symmetry, including a first symmetry axis (e.g., a y-axis) that corresponds to the first scanning axis 110 and a second symmetry axis (e.g., an x-axis) that corresponds to the second scanning axis 112. The first symmetry axis extends vertically, but provides horizontal symmetry. The second symmetry axis extends horizontally, but provides vertical symmetry.

The stiffening structure 204 is arranged underneath the mirror plate 202 and is configured to support the mirror plate 202. The stiffening structure 204 may add rigidity to the mirror plate 202 and reduce dynamic deformation of the reflective surface. Meanwhile, the stiffening structure 204 may be designed with a reduced mass construction in order to reduce an inertia of the scanning structure 200 during a scanning operation.

The stiffening structure may have a first outer diameter OD1 that is equal to or greater than an outer diameter of the mirror plate 202. The connector ring 206 may have a ring-shaped construction that is larger than the first outer diameter OD1. For example, the connector ring may have an inner diameter ID and a second outer diameter OD2 that are both greater than the first outer diameter OD1 of the stiffening structure 204. Thus, a radial gap 214 may exist between the connector ring 206 and the stiffening structure 204 in a radial direction. “Radial direction” means a direction in the x-y plane that extends from a center axis 216. The center axis 216 may extend in a z-direction and may be an axis of symmetry.

The connector ring 206 may be connected to the stiffening structure 204 by a plurality of connector structures or anchor structures (e.g., connections) (not illustrated in FIG. 2A), as will be described in more detail in reference to FIGS. 2B and 2C.

The stiffening structure 204 may include an inner cylinder 218, one or more rings 220 and 222, and at least two radial bars 224. The inner cylinder 218 is arranged at a center of the stiffening structure 204 and is symmetric with respect to the center axis 216. The inner cylinder 218 may be a solid inner cylinder made of solid construction (e.g., not a hollow cylinder). Ring 220 is an outer ring arranged at a circumferential edge of the mirror plate 202. The outer ring 220 has the first outer diameter OD1. The stiffening structure 204 includes two or more radial bars 224 that extend in respective radial directions and are coupled to the inner cylinder 218 and the outer ring 220.

The stiffening structure 204 may optionally include an inner ring 222 arranged between the inner cylinder 218 and the outer ring 220. Thus, the radial bars 224 may be coupled to the inner ring 222. In other words, some radial bars 224 may be directly coupled to the inner cylinder 218 and the inner ring 222 and some radial bars 224 may be directly coupled to the inner ring 222 and the outer ring 220. Nevertheless, the radial bars 224 are used to couple the inner cylinder 218 and the outer ring 220, either directly or indirectly. Moreover, the radial bars 224 provide structural support and rigidity to the mirror plate 202, and may reduce dynamic deformation of the reflective surface. In addition, areas in the stiffening structure 204 between the radial bars 224 are reduced-mass areas, which may reduce an inertia of the scanning structure 200 during a scanning operation. For example, the areas in the stiffening structure 204 between the radial bars 224 may be devoid of material.

The outer ring 220 is an outer-most ring that is coupled to the connector ring 206 and is concentric with the inner cylinder 218. The inner cylinder 218 may have first radius R1 and the mirror plate 202 may have a second radius R2. The first radius R1 may be between ⅕ to ½ of the second radius R2. A ratio of radii between the first radius R1 and the second first radius R2 may ensure that the inner cylinder 218 is large enough to provide sufficient stiffness (rigidity) and structural support to the mirror plate 202, while small enough not to add too much mass and hence inertia during a scanning operation. Thus, the ratio of radii provides a desired balance between limiting inertia and providing stiffness and support to the mirror plate 202.

In some implementations, the outer ring 220 and the mirror plate 202 have equal radii. One or more inner rings (e.g., inner ring 222) may be provided that are concentric with the outer ring 220. The radial bars 224 may extend in one or more radial directions, and may connect the inner cylinder 218 to each ring of the stiffening structure 204. Imaginary extensions of the radial bars 224 may intersect at a center of the inner cylinder 218. The radial bars 224 may be axially symmetric about the two axes of symmetry (e.g., the x- and y-axes). The outer ring 220 may be located at a border of the mirror plate 202 (e.g., at the outer diameter of the mirror plate) to provide support to an outer edge of the mirror plate 202. In some implementations, the inner cylinder 218 may be replaced by another inner ring or a hollow cylinder

The scanning structure 200 may be made of a plurality of layers (e.g., a plurality of semiconductor layers), including a first layer L1, a second layer L2, and a third layer L3. The mirror plate 202 may be formed by the first layer L1, and the reflective surface may be formed by a metallization or a reflective layer disposed on the first layer L1. The stiffening structure 204 may be formed by the first layer L1 and the second layer L2 or by the first layer L1, the second layer L2, and the third layer L3. The connector ring 206 may be formed by the first layer L1 and the second layer L2 or by the first layer L1, the second layer L2, and the third layer L3. The first layer L1, the second layer L2, and the third layer L3 may be formed from a same semiconductor substrate or may be formed by different semiconductor substrates which have been attached to each other by suitable techniques, such as semiconductor wafer bonding.

The outer diameter of the mirror plate 202 may be in a range of 1-2.5 mm. The mirror plate 202 may have a thickness of 5-30 μm and may be defined by the first layer L1. The second layer L2 may have a thickness of 40-140 μm. The third layer L3 may have a thickness of 60-300 μm. The mirror plate 202 is supported by the stiffening structure 204. An aspect ratio of the stiffening structure 204 (e.g., a height of stiffening structure 204 to a width of stiffening structure 204) may be in a range between 8 to 20. The connector ring 206 may have a same thickness as a combined thickness of the stiffening structure 204 and the mirror plate 202, or the connector ring 206 may have a smaller thickness than the combined thickness of the stiffening structure 204 and the mirror plate 202. These dimensions greatly reduce the dynamic deformation of an oscillating mirror (e.g., the mirror plate 202) in two perpendicular oscillation axes. In addition, these dimensions significantly improve a modulation transfer function, which represents an optical performance of the oscillating mirror.

Turning to FIG. 2B, FIG. 2B shows a bottom view of the scanning structure 200. The connector ring 206 may be coupled to suspension structures 226 that extend along the second symmetry axis. The suspension structures 226 may be part of a suspension system that couples the scanning structure 200 to a frame. A plurality of radial bars 224 are visible with gaps between the radial bars to reduce a mass of the stiffening structure 204. The lower surface 210 of the mirror plate 202 is visible in the gaps between the radial bars 224. The plurality of radial bars 224 may provide stiffening and support to the mirror plate 202.

The stiffening structure 204 includes two or more radial bars 224a that extend in respective radial directions and are coupled to the inner cylinder 218 and the outer ring 220. Each radial bar 224a may be arranged at a first absolute radial angle ω1 relative to the first symmetry axis. “Absolute radial angle” means a radial angle that could be either positive or negative relative to a reference point, such as an axis. For example, an absolute radial angle of a radial angle that is +10° or −10° is 10°.

A plurality of connector structures 228 connect the connector ring 206 to the stiffening structure 204. Each connector structure 228 may be arranged in the radial gap 214 and extends in a radial direction between connector ring 206 and the stiffening structure 204. In addition, each connector structure 228 may be arranged at a second absolute radial angle ω1 relative to the first symmetry axis, the second absolute radial angle ω2 being less than or equal to the first absolute radial angle ω1. The second absolute radial angle ω2 extends to an outer radial side of a connector structures 228. In the example shown in FIG. 2B, four connector structures 228 are provided. The connector structures 228 may be short beams that anchor the stiffening structure 204 to the connector ring 206. Thus, the mirror plate 202 may be anchored to the connector ring 206 by virtue of the stiffening structure 204 being mechanically coupled to the connector ring 206. Each connector structure 228 may have a width in a range of 2° to 18°. In some implementations, each connector structure 228 may have a width in a range of 2° to 3°. A smaller connector structure width (e.g., between 2° to 3°) may be preferred for lowering inertia of the scanning structure 200. However, a larger connector structure width (e.g., between 3° to 18°) may be preferred for lowering dynamic deformation of the oscillating mirror.

The connector ring 206 may be coupled to the suspension assembly of the scanning structure 200. For example, in some implementations, springs may be attached to the connector ring 206 at attachment locations located at each intersection of a scanning axis. In some implementations, the springs may be attached to the connector ring at attachment locations that are offset from the scanning axes. The suspension structures 226 may be an example of two springs. The scanning structure 200 may be suspended by the suspension assembly over a mirror cavity that allows a full oscillation range (e.g., deflection range) of the scanning structure 200.

The stiffening structure may include two additional radial bars 224b that are colinear with the second symmetry axis. Thus, the additional radial bars 224b may extend in respective radial directions and are coupled to the inner cylinder 218 and the outer ring 220.

The stiffening structure 204 may include two or more additional radial bars 224c that extend in respective radial directions and are coupled to the inner cylinder 218 and the outer ring 220. Each additional radial bar 224c may be arranged at a third absolute radial angle ω3 relative to the first symmetry axis, the third absolute radial angle ω3 being less than the second absolute radial angle ω2. In some implementations, the second absolute radial angle ω2 is in a range of 8° to 18° to ensure that the radial bars 224a and/or 224c provide sufficient stiffness (rigidity) and support to the mirror plate 202.

In some implementations, the stiffening structure 204 includes radial bars 224d that are arranged at arranged at a fourth absolute radial angle ω4 relative to the first symmetry axis. The second absolute radial angle ω2 of the connector structures 228 is less than the fourth absolute radial angle ω4. Additionally, the first absolute radial angle ω1 of radial bars 224a is less than the fourth absolute radial angle ω4 and greater than or equal to the second absolute radial angle ω2. In some implementations, the second absolute radial angle ω2 is in a range of 8° to 18° to ensure that the radial bars 224a, 224c, and/or 224d provide sufficient stiffness (rigidity) and support to the mirror plate 202.

In some implementations, the first scanning axis 110 (e.g., y-axis) corresponding to the first symmetry axis may be a slow axis and the second scanning axis 112 (e.g., x-axis) corresponding to the second symmetry axis may be a fast axis. In other words, an oscillation frequency of the first scanning axis 110 may be less than or slower than an oscillation frequency of the second scanning axis 112. Each connector structure 228 may be arranged from the slow axis by the angle ω2 (or −ω2), which is in the range of 8° to 18° (or −8° to −18°) from the slow axis. Each connector structure 228 may have a width Δ, which is in the range of 2°-18°.

Turning to FIG. 2C, FIG. 2C shows an expanded view of a portion of FIG. 2B. FIG. 2C shows a portions of the stiffening structure 204 and the connector ring 206, which are separated by radial gap 214. Portions of the stiffening structure 204 shown in FIG. 2C include portions of inner cylinder 218, outer ring 220, inner ring 222, radial bars 224a (outer radial bars), and radial bars 224c (inner radial bars). The lower surface 210 of the mirror plate 202 is also visible in the gaps between the radial bars 224. In addition, two connector structures 228 are shown. Each connector structure 228 has a width Δ in a range of 2° to 18°. Thus, width Δ may be equal to or less than ω2. As described above, the width Δ may be a range of 2° to 3°. A smaller connector structure width (e.g., between 2° to 3°) may be preferred for lowering inertia of the scanning structure 200. However, a larger connector structure width (e.g., between 3° to 18°) may be preferred for lowering dynamic deformation of the oscillating mirror. The second absolute radial angle ω2 extends to an outer radial side of a connector structures 228. When the width Δ is equal to 18°, a connector structure 228 may extend to the first symmetry axis and may be conjoined with a counterpart connector structure 228, forming a single connector structure that extends from −18° to 18°.

The position of the connector structures 228 are defined by the second absolute radial angle ω2, which is in a range of 8° to 18°.

The design of the stiffening structure 204 in combination with the connector ring 206 allows to greatly reduce the dynamic deformation of an oscillating mirror (e.g., the mirror plate 202) in two perpendicular oscillation axes. In addition, a modulation transfer function, which represents an optical performance of the oscillating mirror, can be significantly improved.

Thus, FIG. 2C shows connector structure 228 (e.g., attachments) that connect the connector ring 206 to the stiffening structure 204. A position of the connector structure 228 relative to the first symmetry axis (e.g., y-axis) may be defined by the second absolute radial angle ω2, which may be in a range of 8° to 18°. The connector structures 228 may have a width Δ that may be in a range of 2°-18°. The width Δ may be measured in a circumferential direction. In some implementations, each connector structure 228 may be arranged between two respective radial bars (e.g., respective radial bars 224a and 224c) in the circumferential direction. In some implementations, each connector structure 228 may be arranged symmetrically between the two respective radial bars (e.g., respective radial bars 224a and 224c) in the circumferential direction.

The two outer radial bars may be located outside of the two connector structures 228 shown in FIG. 2C. In other words, the radial angles of the two outer radial bars 224 are greater than the radial angles (e.g., angle ω2) of the two connector structures 228. In some implementations, the two inner radial bars 224c may not be included.

As indicated above, FIGS. 2A-2C are provided as examples. Other examples may differ from what is described with regard to FIGS. 2A-2C. The number and arrangement of components shown in FIGS. 2A-2D are provided as an example. In practice, the scanning structure 200 may include additional components, fewer components, different components, or differently arranged components than those shown in FIGS. 2A-2C. Additionally, the scanning structure 200 may be adapted for a 1D MEMS mirror. In other words, the stiffening structure, the connector ring, and the connector structures may be configured for the 1D MEMS mirror that has a single scanning axis. The angle ω described above for positioning the connector structures would be relative to an axis that lies orthogonal to the single scanning axis of the 1D MEMS mirror. For example, if the single scanning axis of the 1D MEMS mirror is the second scanning axis 112 (e.g., the second symmetry axis), the angle ω described above for positioning the connector structures would be relative to the first symmetry axis.

FIG. 3 shows a scanning structure 300 of a MEMS mirror according to one or more implementations. The scanning structure 300 is similar to the scanning structure 200 described in connection with FIGS. 2A-2C, with the exception that the inner ring 222 is made up of straight support bars instead of curved support bars. Thus, each inner ring, including inner ring 222, may have either straight support bars or curved support bars.

The design of the stiffening structure 204 in combination with the connector ring 206 allows to greatly reduce the dynamic deformation of an oscillating mirror (e.g., the mirror plate 202) in two perpendicular oscillation axes. In addition, a modulation transfer function, which represents an optical performance of the oscillating mirror, can be significantly improved.

As indicated above, FIG. 3 is provided as an example. Other examples may differ from what is described with regard to FIG. 3.

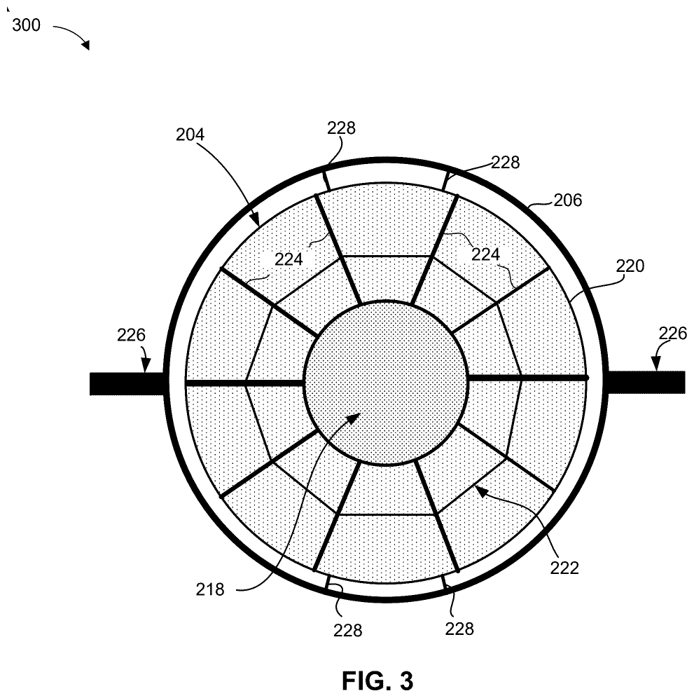

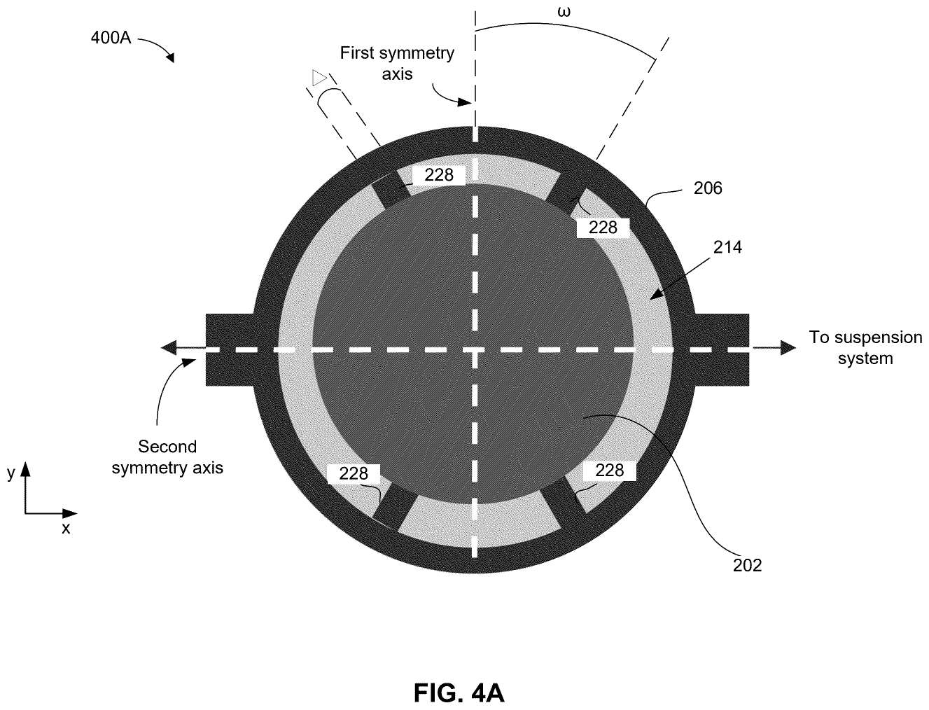

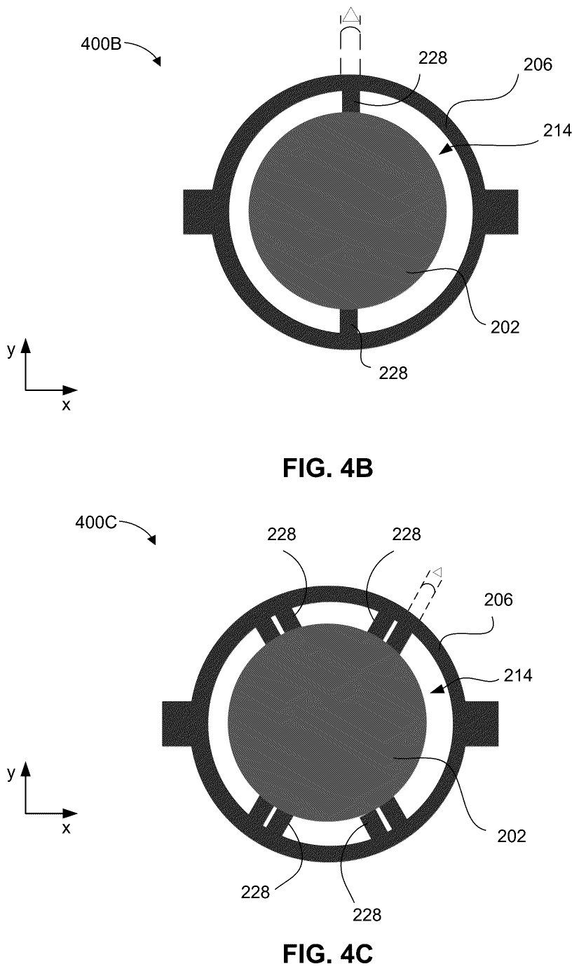

FIGS. 4A-4C show top views of alternative scanning structures of a MEMS mirror according to one or more implementations. The design of the alternative scanning structures in allows dynamic deformation of an oscillating mirror (e.g., the mirror plate 202) to be greatly reduced in two perpendicular oscillation axes. In addition, a modulation transfer function, which represents an optical performance of the oscillating mirror, can be significantly improved.

FIG. 4A shows a scanning structure 400A with four connector structures 228 that are symmetrically arranged with respect to the y-axis (e.g., one of the two rotation axes). The scanning structure 400A includes the mirror plate 202, the stiffening structure 204 arranged underneath the mirror plate 202 (not visible), and the connector ring 206 that is spaced apart from the mirror plate 202 and the stiffening structure 204 by a radial gap 214.

A position of the connector structures 228 relative to the first symmetry axis (e.g., y-axis) may be defined by an absolute radial angle ω, which may be in a range of 8° to 18°. In addition, the connector structures 228 may have a width Δ that may be in a range of 2°-18°.

FIG. 4B shows a scanning structure 400B shows a scanning structure 400A with two connector structures 228 that are symmetrically arranged with respect to the y-axis (e.g., one of the two rotation axes). In this example, the connector structures 228 are aligned with the y-axis. The connector structures 228 may have a width Δ that may be in a range of 8°−18°.

FIG. 4C shows a scanning structure 400C with eight connector structures 228 that are symmetrically arranged with respect to the y-axis (e.g., one of the two rotation axes). Positions of the connector structures 228 relative to the first symmetry axis (e.g., y-axis) may be defined by respective absolute radial angles, which may be in a range of 0° to 18°. The connector structures 228 may have a width Δ that may be in a range of 2°-10°.

As indicated above, FIGS. 4A-4C are provided as examples. Other examples may differ from what is described with regard to FIGS. 4A-4C.

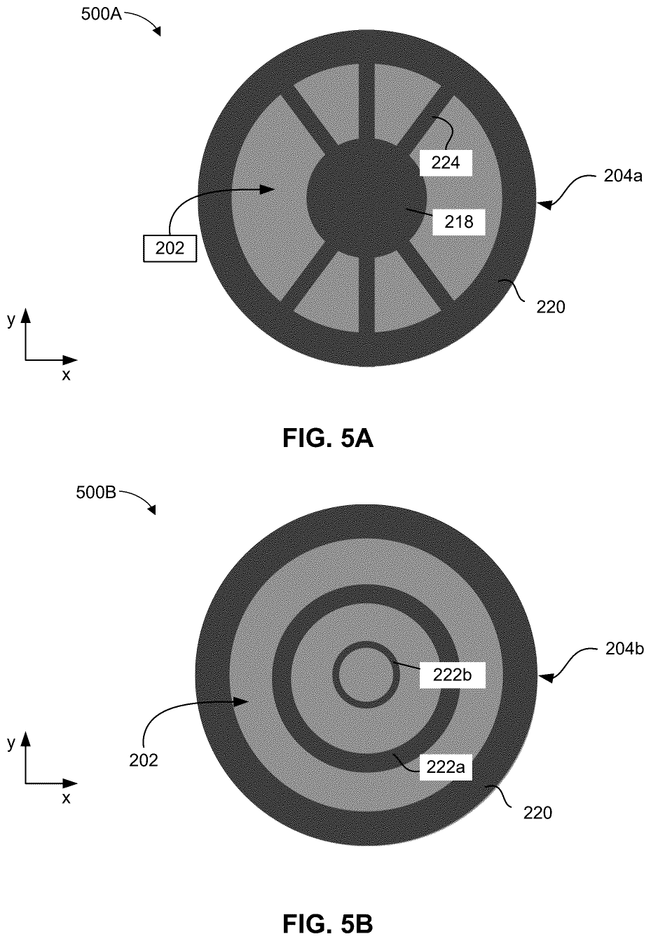

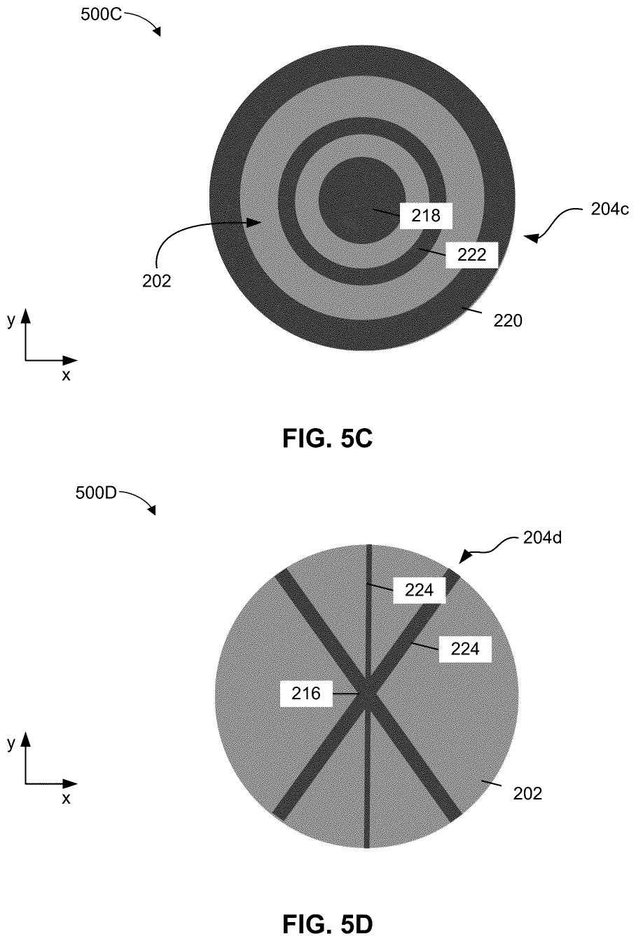

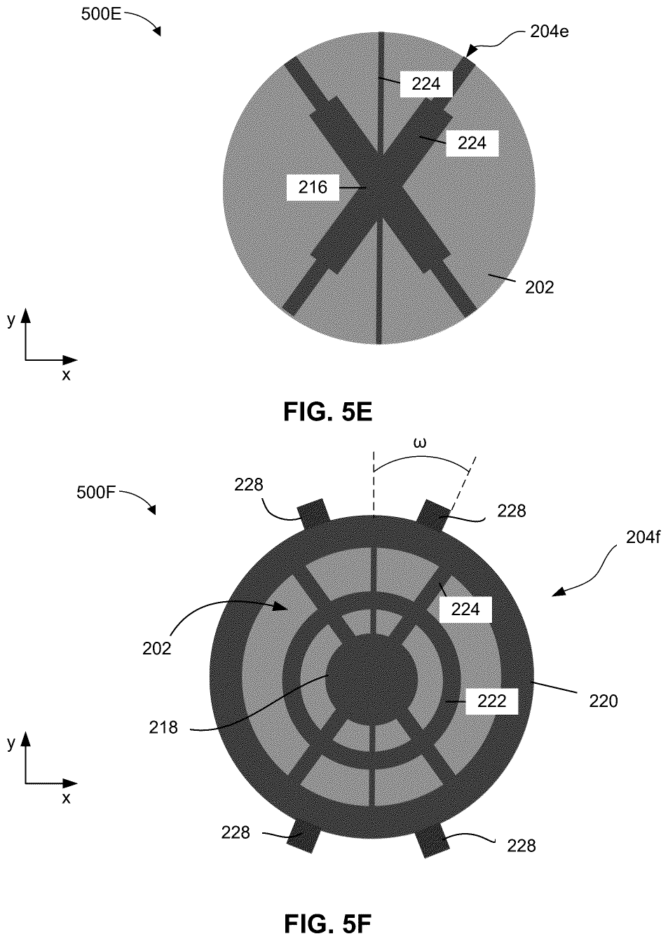

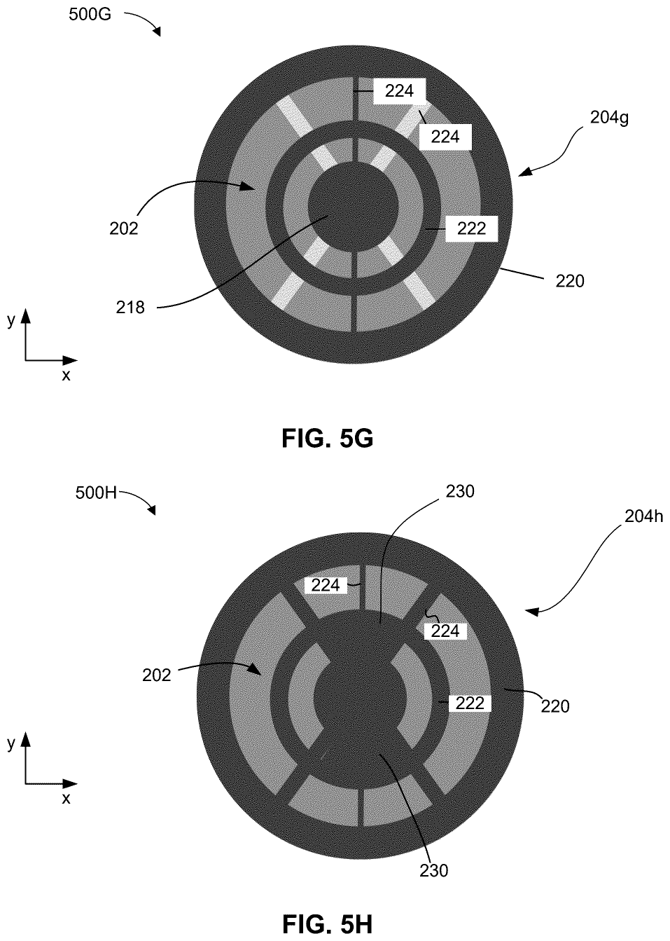

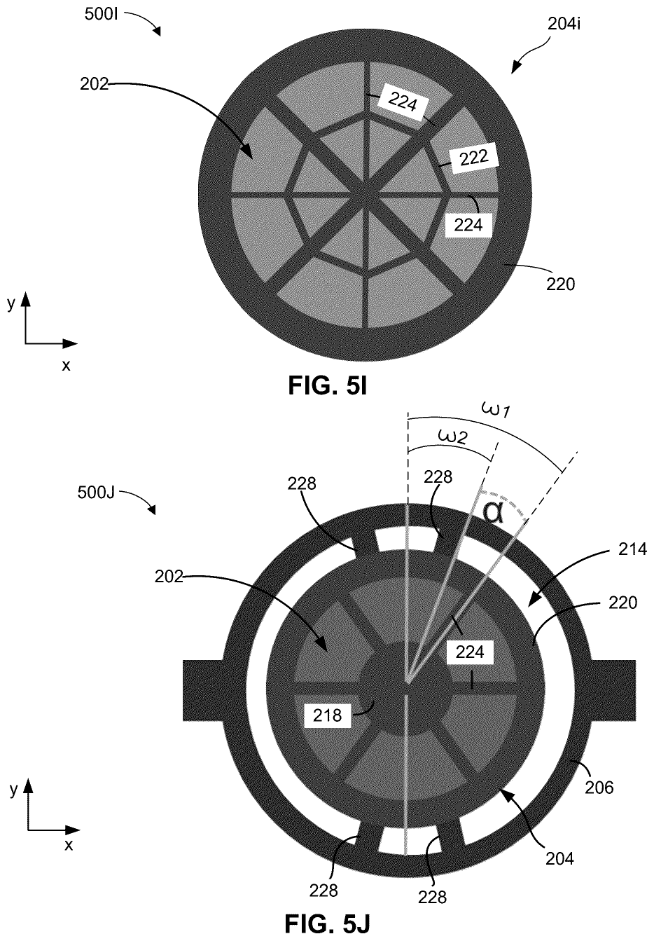

FIGS. 5A-5J show bottom views of alternative scanning structures of a MEMS mirror according to one or more implementations. The design of the alternative scanning structures in allows dynamic deformation of an oscillating mirror (e.g., the mirror plate 202) to be greatly reduced in two perpendicular oscillation axes. In addition, a modulation transfer function, which represents an optical performance of the oscillating mirror, can be significantly improved. The alternative stiffening structures may be coupled to a connector ring by connector structure, as described above.

FIG. 5A shows a scanning structure 500A with a stiffening structure 204a that has six radial bars 224 directly coupled to the inner cylinder 218 and the outer ring 220 of the stiffening structure 204.

The six radial bars 224 are symmetrically arranged with respect to the first symmetry axis (e.g., the y-axis), which is one of the two rotation axes. Two radial bars 224 are aligned with the first symmetry axis, and the other radial bars 224 may be defined by a respective absolute radial angle relative to the first symmetry axis.

FIG. 5B shows a scanning structure 500B with a stiffening structure 204b that has an outer ring 220 and multiple inner rings 222a and 222b. An inner-most ring 222b may take the place of the inner cylinder 218. The inner rings 222a and 222b may have similar or different widths. In this example, the stiffening structure 204 does not have any radial bars.

FIG. 5C shows a scanning structure 500C with a stiffening structure 204c that has an inner cylinder 218, an outer ring 220, an inner ring 222, without any radial bars.

FIG. 5D shows a scanning structure 500D with a stiffening structure 204d that has six radial bars 224 that are connected at a center axis 216. Two radial bars 224 are aligned with the first symmetry axis (e.g., the y-axis), and the other radial bars 224 may be defined by a respective absolute radial angle relative to the first symmetry axis. The six radial bars 224 may have similar or different widths.

FIG. 5E shows a scanning structure 500E with a stiffening structure 204e that has six radial bars 224 that are connected at a center axis 216. Two radial bars 224 are aligned with the first symmetry axis, and the other radial bars 224 may be defined by a respective absolute radial angle relative to the first symmetry axis, the respective absolute radial angle being in a range of 8° to 18°. Some of the radial bars 224 may have variable widths to provide more stiffness/rigidity in a central region of the mirror plate 202 and less stiffness in a peripheral region of the mirror plate 202. In this example, the stiffening structure 204 does not contain any ring-support structures, such as outer ring 220 or inner ring 222.

FIG. 5F shows a scanning structure 500F with a stiffening structure 204f that has a combination of six radial bars 224, an inner cylinder 218, an outer ring 220, and an inner ring 222. Two radial bars 224 are aligned with the first symmetry axis (e.g., the y-axis), and the other radial bars 224 may be defined by a respective absolute radial angle relative to the first symmetry axis. Four of the radial bars are outside an angular position of the connector structures 228. The connector structures 228 are located at respective absolute radial angle ω being in a range of 8° to 18°. The connector structures 228 have a width Δ that is in a range of 2°-18°. The connector structures 228 are symmetrically arranged with respect to the first symmetry axis.

FIG. 5G shows a scanning structure 500G with a stiffening structure 204g that has a combination of six radial bars 224, an inner cylinder 218, an outer ring 220, and an inner ring 222, similar to the stiffening structure 204f described in connection with FIG. 5F. However, the six radial bars 224, an inner cylinder 218, an outer ring 220, an inner ring 222 may be arranged at different layers or different layer heights. For example, the radial bar 224 may be arranged at layer L2, and the inner cylinder 218, the outer ring 220, and the inner ring 222 may be arranged at layer L3, or vice versa. Alternatively, the inner cylinder 218, the outer ring 220, and the inner ring 222 may be formed by layers L2 and L3.

FIG. 5H shows a scanning structure 500H with a stiffening structure 204h that has a combination of six radial bars 224, an inner cylinder 218, an outer ring 220, and an inner ring 222, similar to the stiffening structure 204f described in connection with FIG. 5F. In addition, the stiffening structure 204 includes additional support sections 230 in areas between the inner cylinder 218 and the inner ring 222.

FIG. 5I shows a scanning structure 500I with a stiffening structure 204i that has a combination of eight radial bars 224, an outer ring 220, and an inner ring 222. The inner ring 22 is made of straight support bars. The stiffening structure 204 may be symmetric with respect to the first symmetry axis (e.g., the y-axis) and the second symmetry axis (e.g., the x-axis).

FIG. 5J shows a scanning structure 500J with a stiffening structure 204j and a connector ring 206. The stiffening structure 204 includes six radial bars 224, an inner cylinder 218, and an outer ring 220. Two of the radial bars 224 are aligned with the second symmetry axis (e.g., the x-axis). Four radial bars 224 are arranged at an absolute radial angle ω1 relative to the first symmetry axis (e.g., the y-axis) The four radial bars 224 are arranged outside an angular position of the connector structures 228 or at the same angular position as the connector structures 228. The connector structures 228 may be arranged at an absolute radial angle ω2 relative to the first symmetry axis, the absolute radial angle ω2 being in a range of 8° to 18°. In addition, the four radial bars 224 are placed at an absolute radial angle α relative to the connector structures 228. The absolute radial angle α may be 10° to reduce dynamic deformation of the oscillating mirror. Thus, the absolute radial angle ω1 may be in a range of 18° to 28°. The inner cylinder 218 may have first radius R1 and the mirror plate 202 may have a second radius R2. The first radius R1 may be between ⅓ to ½ of the second radius R2 to stiffen the mirror plate 202, while at the same time preventing high inertia.

As indicated above, FIGS. 5A-5J are provided as examples. Other examples may differ from what is described with regard to FIGS. 5A-5J.

The following provides an overview of some Aspects of the present disclosure:

Aspect 1: A method, a device, a system, an apparatus, an optical device, an optical system, an optical assembly, a beam scanning system, and/or a scanning structure, as substantially described herein with reference to and as illustrated by the accompanying specification, appendix, and drawings.

Aspect 2: A scanning structure, comprising: a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an inner cylinder arranged at a center of the stiffening structure; an outer ring arranged at a circumferential edge of the mirror plate, wherein the outer ring has a first outer diameter; and two or more radial bars that extend in respective radial directions and are coupled to the inner cylinder and the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

Aspect 3: The scanning structure of Aspect 2, wherein the connector ring is coupled to a suspension system.

Aspect 4: The scanning structure of any of Aspects 2-3, wherein the inner cylinder has a first radius and the mirror plate has a second radius, and wherein the first radius is between ⅕ to ½ of the second radius.

Aspect 5: The scanning structure of any of Aspects 2-4, wherein the stiffening structure includes two additional radial bars that are colinear with the second symmetry axis, wherein the two additional radial bars extend in respective radial directions and are coupled to the inner cylinder and the outer ring.

Aspect 6: The scanning structure of any of Aspects 2-5, wherein the stiffening structure includes an inner ring arranged between the inner cylinder and the outer ring, wherein the two or more radial bars are coupled to the inner ring.

Aspect 7: The scanning structure of any of Aspects 2-6, wherein the plurality of connector structures include four connector structures.

Aspect 8: The scanning structure of any of Aspects 2-7, wherein the stiffening structure includes two or more additional radial bars that extend in respective radial directions and are coupled to the inner cylinder and the outer ring, wherein each additional radial bar of the two or more additional radial bars is arranged at a third absolute radial angle relative to the first symmetry axis, wherein the third absolute radial angle is less than the first absolute radial angle and greater than the second absolute radial angle.

Aspect 9: The scanning structure of Aspect 8, wherein the second absolute radial angle is in a range of 8° to 18°.

Aspect 10: The scanning structure of any of Aspects 2-9, wherein the stiffening structure includes two or more additional radial bars that extend in respective radial directions and are coupled to the inner cylinder and the outer ring, wherein each additional radial bar of the two or more additional radial bars is arranged at a third absolute radial angle relative to the first symmetry axis, wherein the third absolute radial angle is less than the second absolute radial angle.

Aspect 11: The scanning structure of Aspect 10, wherein the second absolute radial angle is in a range of 8° to 18°.

Aspect 12: The scanning structure of any of Aspects 2-11, wherein each connector structure of the plurality of connector structures has a width in a range of 2° to 18°.

Aspect 13: The scanning structure of any of Aspects 2-12, wherein the mirror plate has an outer diameter of in a range of 1-2.5 mm, and a thickness in a range of 5-30 μm.

Aspect 14: The scanning structure of any of Aspects 2-13, wherein the first scanning axis is a slow axis and the second scanning axis is a fast axis.

Aspect 15: A scanning structure, comprising: a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an outer ring arranged at a circumferential edge of the mirror plate, wherein the outer ring has a first outer diameter; and two radial bars that extend in respective radial directions and intersect at a center of the stiffening structure, wherein the two radial bars are coupled to the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

Aspect 16: The scanning structure of Aspect 15, wherein the stiffening structure includes an inner ring arranged between the inner cylinder and the center of the stiffening structure, wherein the two radial bars are coupled to the inner ring.

Aspect 17: The scanning structure of any of Aspects 15-16, wherein the stiffening structure includes an inner cylinder arranged at the center of the stiffening structure and coupled to the two radial bars.

Aspect 18: The scanning structure of any of Aspects 15-17, wherein the plurality of connector structures include four connector structures.

Aspect 19: The scanning structure of any of Aspects 15-18, wherein the stiffening structure includes two additional radial bars that extend in respective radial directions and are coupled to the outer ring, wherein each additional radial bar of the two additional radial bars is arranged at a third absolute radial angle relative to the first symmetry axis, wherein the third absolute radial angle is less than the first absolute radial angle and greater than the second absolute radial angle.

Aspect 20: The scanning structure of Aspect 19, wherein the second absolute radial angle is in a range of 8° to 18°.

Aspect 21: The scanning structure of any of Aspects 15-20, wherein the stiffening structure includes two additional radial bars that extend in respective radial directions and are coupled to the outer ring, wherein each additional radial bar of the two additional radial bars is arranged at a third absolute radial angle relative to the first symmetry axis, wherein the third absolute radial angle is less than the second absolute radial angle.

Aspect 22: The scanning structure of Aspect 21, wherein the second absolute radial angle is in a range of 8° to 18°.

Aspect 23: The scanning structure of any of Aspects 15-22, wherein each connector structure of the plurality of connector structures has a width in a range of 2° to 18°.

Aspect 24: The scanning structure of any of Aspects 15-23, wherein the mirror plate has an outer diameter of in a range of 1-2.5 mm, and a thickness in a range of 5-30 μm.

Aspect 25: The scanning structure of any of Aspects 15-24, wherein the first scanning axis is a slow axis and the second scanning axis is a fast axis.

Aspect 26: A scanning structure, comprising: a mirror plate comprising an upper surface, a lower surface, a first symmetry axis, a second symmetry axis that is orthogonal to the first symmetry axis and is coincident with a scanning axis, wherein a reflective layer is arranged on the upper surface to form a reflective surface; a stiffening structure arranged underneath the mirror plate and coupled to the lower surface of the mirror plate, wherein the stiffening structure is configured to support the mirror plate, wherein the stiffening structure includes: an inner cylinder arranged at a center of the stiffening structure; an outer ring arranged at a circumferential edge of the mirror plate, wherein the outer ring has a first outer diameter; and two or more radial bars that extend in respective radial directions and are coupled to the inner cylinder and the outer ring, wherein each radial bar of the two or more radial bars is arranged at a first absolute radial angle relative to the first symmetry axis; and a connector ring coupled to the outer ring by a plurality of connector structures, wherein the connector ring has an inner diameter that is larger than the first outer diameter such that the connector ring and the outer ring are separated by a radial gap, wherein each connector structure of the plurality of connector structures is arranged in the radial gap and extends in the radial direction, and wherein each connector structure of the plurality of connector structures is arranged at a second absolute radial angle relative to the first symmetry axis, wherein the second absolute radial angle is less than or equal to the first absolute radial angle.

Aspect 27: The scanning structure of Aspect 26, wherein the scanning structure is a one-dimensional microelectromechanical system (MEMS) mirror having only a single scanning axis.

Aspect 28: The scanning structure of any of Aspects 26-27, wherein the second absolute radial angle is in a range of 8° to 18°.

Aspect 29: A system configured to perform one or more operations recited in one or more of Aspects 1-28.

Aspect 30: An apparatus comprising means for performing one or more operations recited in one or more of Aspects 1-28.

Further disclosure is included in the appendix. The appendix is provided as an example only, and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

The foregoing disclosure provides illustration and description, but is not intended to be exhaustive or to limit the implementations to the precise form disclosed. Modifications and variations may be made in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

Some implementations may be described herein in connection with thresholds. As used herein, “satisfying” a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, the term “component” is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a and b, a and c, b and c, and a, b, and c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A scanning structure, comprising:
a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface;
a stiffening structure arranged underneath the mirror plate and coupled to the lower surface of the mirror plate, wherein the stiffening structure is configured to support the mirror plate,
wherein the stiffening structure includes:
an inner cylinder arranged at a center of the stiffening structure;
an outer ring arranged at a circumferential edge of the mirror plate, wherein the outer ring has a first outer diameter; and
two or more radial bars that extend in respective radial directions and are coupled to the inner cylinder and the outer ring, wherein each radial bar of the two or more radial bars is arranged at a first absolute radial angle relative to the first symmetry axis; and
a connector ring coupled to the outer ring by a plurality of connector structures, wherein the connector ring has an inner diameter that is larger than the first outer diameter such that the connector ring and the outer ring are separated by a radial gap,
wherein each connector structure of the plurality of connector structures is arranged in the radial gap and extends in the radial direction, and
wherein each connector structure of the plurality of connector structures is arranged at a second absolute radial angle relative to the first symmetry axis, wherein the second absolute radial angle is less than or equal to the first absolute radial angle.

2. The scanning structure of claim 1, wherein the connector ring is coupled to a suspension system.

3. The scanning structure of claim 1, wherein the inner cylinder has a first radius and the mirror plate has a second radius, and
wherein the first radius is between ⅕ to ½ of the second radius.

4. The scanning structure of claim 1, wherein the stiffening structure includes two additional radial bars that are colinear with the second symmetry axis, wherein the
two additional radial bars extend in respective radial directions and are coupled to the inner cylinder and the outer ring.

5. The scanning structure of claim 1, wherein the stiffening structure includes an inner ring arranged between the inner cylinder and the outer ring,
wherein the two or more radial bars are coupled to the inner ring.

6. The scanning structure of claim 1, wherein the plurality of connector structures include four connector structures.

7. The scanning structure of claim 1, wherein the stiffening structure includes two or more additional radial bars that extend in respective radial directions and are coupled to the inner cylinder and the outer ring, wherein each additional radial bar of the two or more additional radial bars is arranged at a third absolute radial angle relative to the first symmetry axis, wherein the third absolute radial angle is less than the first absolute radial angle and greater than the second absolute radial angle.

8. The scanning structure of claim 7, wherein the second absolute radial angle is in a range of 8° to 18°.

9. The scanning structure of claim 1, wherein the stiffening structure includes two or more additional radial bars that extend in respective radial directions and are coupled to the inner cylinder and the outer ring, wherein each additional radial bar of the two or more additional radial bars is arranged at a third absolute radial angle relative to the first symmetry axis, wherein the third absolute radial angle is less than the second absolute radial angle.

10. The scanning structure of claim 9, wherein the second absolute radial angle is in a range of 8° to 18°.

11. The scanning structure of claim 1, wherein each connector structure of the plurality of connector structures has a width in a range of 2° to 18°.

12. The scanning structure of claim 1, wherein the mirror plate has an outer diameter of in a range of 1-2.5 mm, and a thickness in a range of 5-30 μm.

13. The scanning structure of claim 1, wherein the first scanning axis is a slow axis and the second scanning axis is a fast axis.

14. A scanning structure, comprising:
a mirror plate comprising an upper surface, a lower surface, a first symmetry axis coincident with a first scanning axis, a second symmetry axis coincident with a second scanning axis that is orthogonal to the first scanning axis, wherein a reflective layer is arranged on the upper surface to form a reflective surface;
a stiffening structure arranged underneath the mirror plate and coupled to the lower surface of the mirror plate, wherein the stiffening structure is configured to support the mirror plate,
wherein the stiffening structure includes:
an outer ring arranged at a circumferential edge of the mirror plate, wherein the outer ring has a first outer diameter; and
two radial bars that extend in respective radial directions and intersect at a center of the stiffening structure, wherein the two radial bars are coupled to the outer ring, wherein each radial bar of the two radial bars is arranged at a first absolute radial angle relative to the first symmetry axis; and
a connector ring coupled to the outer ring by a plurality of connector structures, wherein the connector ring has an inner diameter that is larger than the first outer diameter such that the connector ring and the outer ring are separated by a radial gap,
wherein each connector structure of the plurality of connector structures is arranged in the radial gap and extends in the radial direction, and
wherein each connector structure of the plurality of connector structures is arranged at a second absolute radial angle relative to the first symmetry axis, wherein the second absolute radial angle is less than or equal to the first absolute radial angle.

15. The scanning structure of claim 14, wherein the stiffening structure includes an inner ring arranged between the outer ring and the center of the stiffening structure,
wherein the two radial bars are coupled to the inner ring.

16. The scanning structure of claim 14, wherein the stiffening structure includes an inner cylinder arranged at the center of the stiffening structure and coupled to the two radial bars.

17. The scanning structure of claim 14, wherein the plurality of connector structures include four connector structures.

18. The scanning structure of claim 14, wherein the stiffening structure includes two additional radial bars that extend in respective radial directions and are coupled to the outer ring, wherein each additional radial bar of the two additional radial bars is arranged at a third absolute radial angle relative to the first symmetry axis, wherein the third absolute radial angle is less than the first absolute radial angle and greater than the second absolute radial angle.

19. The scanning structure of claim 18, wherein the second absolute radial angle is in a range of 8° to 18°.

20. The scanning structure of claim 14, wherein the stiffening structure includes two additional radial bars that extend in respective radial directions and are coupled to the outer ring, wherein each additional radial bar of the two additional radial bars is arranged at a third absolute radial angle relative to the first symmetry axis, wherein the third absolute radial angle is less than the second absolute radial angle.

21. The scanning structure of claim 20, wherein the second absolute radial angle is in a range of 8° to 18°.

22. The scanning structure of claim 14, wherein each connector structure of the plurality of connector structures has a width in a range of 2° to 18°.

23. The scanning structure of claim 14, wherein the mirror plate has an outer diameter of in a range of 1-2.5 mm, and a thickness in a range of 5-30 μm.

24. The scanning structure of claim 14, wherein the first scanning axis is a slow axis and the second scanning axis is a fast axis.

25. A scanning structure, comprising:
a mirror plate comprising an upper surface, a lower surface, a first symmetry axis, a second symmetry axis that is orthogonal to the first symmetry axis and is coincident with a scanning axis, wherein a reflective layer is arranged on the upper surface to form a reflective surface;
a stiffening structure arranged underneath the mirror plate and coupled to the lower surface of the mirror plate, wherein the stiffening structure is configured to support the mirror plate,
wherein the stiffening structure includes:
an inner cylinder arranged at a center of the stiffening structure;
an outer ring arranged at a circumferential edge of the mirror plate, wherein the outer ring has a first outer diameter; and
two or more radial bars that extend in respective radial directions and are coupled to the inner cylinder and the outer ring, wherein each radial bar of the two or more radial bars is arranged at a first absolute radial angle relative to the first symmetry axis; and
a connector ring coupled to the outer ring by a plurality of connector structures, wherein the connector ring has an inner diameter that is larger than the first outer diameter such that the connector ring and the outer ring are separated by a radial gap,
wherein each connector structure of the plurality of connector structures is arranged in the radial gap and extends in the radial direction, and
wherein each connector structure of the plurality of connector structures is arranged at a second absolute radial angle relative to the first symmetry axis, wherein the second absolute radial angle is less than or equal to the first absolute radial angle.

26. The scanning structure of claim 25, wherein the scanning structure is a one-dimensional microelectromechanical system (MEMS) mirror having only a single scanning axis.

27. The scanning structure of claim 25, wherein the second absolute radial angle is in a range of 8° to 18°.
